(19) United States
(12) Patent Application Publication
(10) Pub. No.: US 2005/0273385 A1
(43) Pub. Date: Dec. 8, 2005

(54) Electronic advertising contract for granting fuel merchant credit in exchange for placement of advertising on vehicles

(76) Inventor: David Vandervoort, Enfield, CT (US)

Correspondence Address: COHEN, PONTANI, LIEBERMAN & PAVANE, 551 FIFTH AVENUE, SUITE 1210, NEW YORK, NY, 10176, US

(21) Appl. No.: 10/861,001

(22) Filed: Jun. 4, 2004

(51) Int. Cl. G06F 17/60

(52) U.S. Cl. 705/14

(57) ABSTRACT

An electronic advertising contract grants fuel credits in exchange for placement of advertising on private and/or commercial vehicles. The contract is implemented using a vehicle equipped with an advertisement detection mechanism. The advertisement detection mechanism detects at least one of presence of an advertisement positioned for vehicle display and absence of an advertisement positioned for vehicle display. A processing mechanism, coupled to the advertisement detection mechanism, a clocking mechanism, and memory, generates an electronic advertisement display log in memory setting forth at least one of a time interval for which a display of the advertisement is detected, a time interval for which a display of the advertisement is not detected, a mileage interval for which a display of the advertisement is detected, and a mileage interval for which a display of the advertisement is not detected. The electronic advertisement display log is updated periodically or at predetermined intervals. The electronic advertisement display log is updated by the processing mechanism receiving data from at least one of the clocking mechanism, the GPS system, the OBD connector, and the OBD-II connector specifying at least one of a time and a mileage figure.

### BACKGROUND OF THE INVENTION

If a roadside billboard is creatively designed and well-positioned, it may catch the glance of a passing motorist for a quick moment. By way of comparison, surrounding vehicles generally remain within visual range for longer periods of time. Advertisers have advantageously exploited the high visibility of commercial vehicles by placing advertisements on buses, trucks, company vans, and taxicabs. Commercial vehicles often adhere to predetermined schedules or routes, enabling advertising organizations to target specific groups of consumers in specific geographic areas with reasonable assurance that their advertisement has received a desired amount of exposure.

From the standpoint of many advertisers, placing advertisements on private vehicles is a risky proposition. Private vehicles may not adhere to a regular schedule and, moreover, they do not necessarily travel along a predetermined route. An owner or lessee of a private vehicle may accept revenue for the display of an advertisement, and then fail to display the advertisement as agreed, perhaps due to a perception that the advertisement degrades the vehicle's appearance. The advertiser, desirous of obtaining a specified level of exposure to an advertisement, may offer payments to a vehicle owner as a function of miles driven or time spent behind the wheel. However, it is quite difficult for the advertiser to verify that the requisite number of miles was, in fact, driven, or that the requisite amount of time was, in fact, spent behind the wheel.

Despite the foregoing shortcomings, advertising on private vehicles may prove advantageous in certain situations. Some advertisers may wish to reach customers in quiet rural or suburban areas where private vehicles greatly outnumber commercial vehicles. Additionally, certain private vehicles are especially well suited for carrying advertisements. Many sport utility vehicles (SUVs), light trucks, and vans have large, flat rear and side windows that can be readily adapted to displaying advertisements. In recent years, there has been a large upsurge in the sale of such vehicles. Meanwhile, the price of gasoline has also increased dramatically over the past few years. Many owners of large, heavy vehicles would welcome an opportunity to defray some or all of their refueling expenses. What is needed is a technique for granting fuel credit which provides confirmation that an advertisement has been displayed on a private vehicle for at least a certain number of miles or for at least a certain length of time.

### SUMMARY OF THE INVENTION

An electronic advertising contract grants fuel merchant credits in exchange for placement of advertising on private and/or commercial vehicles. The contract is implemented using a vehicle equipped with an advertisement detection mechanism. The advertisement detection mechanism detects at least one of presence of an advertisement positioned for vehicle display and absence of an advertisement positioned for vehicle display. A processing mechanism, coupled to the advertisement detection mechanism, a clocking mechanism, and memory, generates an electronic advertisement display log in memory setting forth at least one of a time interval for which a display of the advertisement is detected, a time interval for which a display of the advertisement is not detected, a distance interval for which a display of the advertisement is detected, and a distance interval for which a display of the advertisement is not detected. The electronic advertisement display log is updated periodically or at predetermined intervals. As an alternative or addition to periodic or interval-based updates, the electronic advertisement display log may be updated in response to at least one of detection of the presence of an advertisement, and detection of the absence of an advertisement. The processing mechanism is equipped with an input port for accepting data from at least one of a GPS system, an OBD connector, and an OBD-II connector. The electronic advertisement display log is updated by the processing mechanism receiving data from at least one of the clocking mechanism, the GPS system, the OBD connector, and the OBD-II connector specifying at least one of a time and a distance (mileage) figure.

Pursuant to a first embodiment of the invention, the processing mechanism is equipped with an output port for outputting data to a portable data storage device. Illustratively, the portable data storage device includes a magnetic strip card, smart card, electronic key fob, floppy disk, memory stick, compact flash card, portable wireless transceiver, or portable radio frequency identification (RFID) tag. The processing mechanism is programmed to load the portable data storage device with an electronic fuel merchant credit amount determined by retrieving one or more entries from the electronic advertisement display log. The retrieved entries are used to calculate at least one of distance driven while display of the advertisement was detected, time driven while display of the advertisement was detected, and total time elapsed while display of the advertisement was detected. Based upon any of the foregoing calculations, the processing mechanism determines an electronic fuel merchant credit amount that specifies how much fuel merchant credit is available for refueling the vehicle. The fuel merchant credit amount is based upon at least one of the amount of time that the advertisement was displayed with the vehicle, the distance (i.e., number of miles) that the vehicle was driven while displaying the advertisement, and the amount of time that the vehicle was driven while displaying the advertisement. A fuel merchant is equipped with a portable data storage device reader for reading the electronic fuel merchant credit amount from the portable data storage device and accepting the electronic fuel merchant credit in at least partial exchange for dispensing fuel into the vehicle. The portable data storage device reader receives the electronic fuel merchant credit amount from the portable data storage device and sends the electronic fuel merchant credit amount to a fuel station computing system which activates a fuel pump dispensing mechanism to dispense at least an amount of fuel equivalent to the electronic fuel merchant credit amount. Optionally, all or a portion of the fuel merchant credit amount may be used to purchase non-fuel goods or services from a fuel merchant, such as soda, magazines, antifreeze, lottery tickets, or oil changes. Similarly, all or a portion of the fuel merchant credit amount may optionally be used to obtain cash.

Pursuant to a second embodiment of the invention, an RF data transmitter is employed in lieu of, or in addition to, the output port of the processing mechanism. The RF data transmitter is equipped for communicating with an RF data receiver associated with a fuel merchant. In response to at least one of user input and proximity to the RF data receiver, the processing mechanism is programmed to activate the RF data transmitter to transmit an electronic fuel merchant credit amount to the RF data receiver. As before, the electronic fuel merchant credit amount is determined by retrieving one or more entries from the electronic advertisement display log and calculating at least one of distance driven while display of the advertisement was detected, time driven while display of the advertisement was detected, and total time elapsed while display of the advertisement was detected. Based upon any of the foregoing calculations, the processing mechanism determines an electronic fuel merchant credit amount that specifies how much fuel credit is available for refueling the vehicle. The RF data receiver receives the electronic fuel merchant credit amount from the RF data transmitter and sends the electronic fuel merchant credit amount to a fuel station computing system which activates a fuel pump dispensing mechanism to dispense at least an amount of fuel equivalent to the electronic fuel merchant credit amount. Optionally, all or a portion of the fuel merchant credit amount may be used to purchase non-fuel goods or services from a fuel merchant, such as soda, magazines, antifreeze, lottery tickets, or oil changes.

Pursuant to an alternate embodiment of the invention, an advertisement presence detection mechanism is used on or within a vehicle to detect continuous presence of an advertisement positioned for vehicle display throughout substantially all of a predetermined interval of time. The advertisement presence detection mechanism is coupled to a radio frequency identification (RFID) tag for transmitting information including a user identification and a variable indicative of whether or not continuous presence of the advertisement was detected throughout substantially all of the predetermined interval of time. Information transmitted by the RFID tag is received by a data receiver at a fuel merchant and, if continuous presence was detected, the received information is used to determine a fuel merchant credit amount.

### BRIEF DESCRIPTION OF THE DRAWINGS

In the drawings:

FIG. 1 is a hardware block diagram setting forth a system for administering electronic advertising contracts according to a first preferred embodiment of the invention.

FIG. 2 is a hardware block diagram setting forth a system for administering electronic advertising contracts according to a second preferred embodiment of the invention.

FIGS. 3A and 3B together comprise a flowchart setting forth an operational sequence performed by any of the systems of FIGS. 1 and 2.

FIG. 4 is a data structure diagram showing an electronic advertisement display log used to implement the operational sequence of FIGS. 3A and 3B.

### DETAILED DESCRIPTION OF THE PRESENTLY PREFERRED EMBODIMENTS

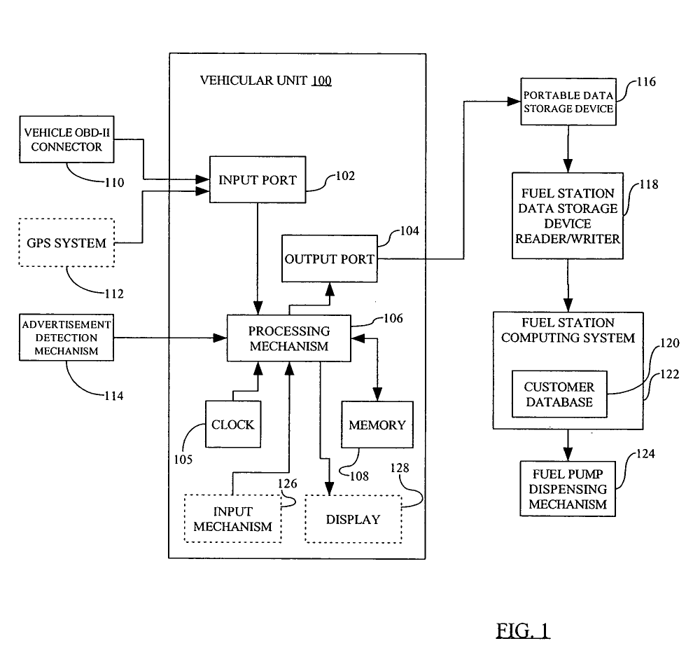

An electronic advertising contract grants fuel merchant credits in exchange for placement of advertising on private and/or commercial vehicles. Fuel merchant credits are electronically stored credits which may be redeemed at a fuel merchant in exchange for fuel. Optionally, fuel merchant credits may be redeemed in exchange for goods or services offered by the fuel merchant, or in exchange for cash. Refer to FIG. 1, which is a hardware block diagram setting forth a system for administering electronic advertising contracts according to a first preferred embodiment of the invention. The contract is implemented using a vehicle equipped with an advertisement detection mechanism 114. The advertisement detection mechanism 114 detects at least one of presence of an advertisement positioned for vehicle display and absence of an advertisement positioned for vehicle display. Illustratively, advertising may take the form of a transparent or semi-transparent film bearing a visual advertisement. The film is intended to adhere to a window glass surface through any of electrostatic charge, an applied adhesive, a window-mounted bracket, a bracket mounted anywhere on the vehicle, Velcro™ strips, or similar attachment means. Optionally, the film may include a dielectric or conductive material to facilitate detection of the film while the film is in a display position on or within the vehicle. Suitable devices for implementing advertisement detection mechanism 114 include one or more contact microswitches, a light source and a photodetector cell, a bracket-mounted switch, a capacitive proximity sensor, a resistance detector, and other similar devices.

A processing mechanism 106, coupled to the advertisement detection mechanism 114, generates an electronic advertisement display log in a memory 108. The electronic advertisement display log sets forth at least one of a time interval for which a display of the advertisement is detected, a time interval for which a display of the advertisement is not detected, a distance (i.e., mileage) interval for which a display of the advertisement is detected, and a distance interval for which a display of the advertisement is not detected. Processing mechanism 106 is programmed to determine these distance intervals and time intervals using information received from a clock 105, an input port 102, an optional input mechanism 126, and an optional display 128. Input port 102 accepts data from at least one of an optional GPS system 112, an OBD connector (not shown), and an OBD-II connector 110. The electronic advertisement display log is updated by processing mechanism 106 receiving data from at least one of clock 105, GPS system 112, input mechanism 126, an OBD connector, and OBD-II connector 110 specifying at least one of a time and a distance figure. The electronic advertisement display log is updated periodically or at predetermined intervals. As an alternative or addition to periodic or interval-based updates, the electronic advertisement display log may be updated in response to at least one of detection of the presence of an advertisement, and detection of the absence of an advertisement.

Pursuant to the first preferred embodiment of the invention shown in FIG. 1, processing mechanism 106 is equipped with an output port 104 for outputting data to a portable data storage device 116. Illustratively, portable data storage device 116 includes a magnetic strip card, smart card, electronic key fob, floppy disk, memory stick, compact flash card, portable wireless transceiver, wireless transmitter, or portable radio frequency identification (RFID) tag. Processing mechanism 106 is programmed to electronically load portable data storage device 116 with a fuel merchant credit amount determined by retrieving one or more entries from the electronic advertisement display log stored in memory 108. The retrieved entries are used to calculate at least one of distance driven while display of the advertisement was detected, time driven while display of the advertisement was detected, and total time elapsed while display of the advertisement was detected. Based upon any of the foregoing calculations, processing mechanism 106 determines a fuel merchant credit amount that specifies how much fuel credit is available for refueling the vehicle. Optionally, processing mechanism 106 determines the fuel merchant credit amount by using the foregoing calculations in conjunction with a predetermined vehicle value. The predetermined vehicle value is calculated as a function of one or more of: a) available window display area on the vehicle, b) vehicle make, model, and year, and c) intended vehicle use. Information relating to window display area, vehicle make, model and year, as well as intended vehicle use, may be entered into optional input mechanism 126 and stored in memory 108.

Optionally, all or a portion of the fuel merchant credit amount may be used to purchase non-fuel goods or services from a fuel merchant, such as soda, magazines, antifreeze, lottery tickets, or oil changes. The fuel merchant credit amount is based upon at least one of the amount of time that the advertisement was displayed with the vehicle, the distance that the vehicle was driven while displaying the advertisement, and the amount of time that the vehicle was driven while displaying the advertisement.

A fuel merchant is equipped with a portable data storage device reader/writer 118 for electronically reading the fuel merchant credit amount from portable data storage device 116 and accepting the fuel merchant credit in at least partial exchange for dispensing fuel into the vehicle. However, as stated above, all or a portion of the fuel merchant credit amount may optionally be used to purchase non-fuel goods or services from the fuel merchant. The portable data storage device reader/writer 118 electronically receives the fuel merchant credit amount from portable data storage device 116 and sends the fuel merchant credit amount to a fuel station computing system 122 which activates a fuel pump dispensing mechanism 124 to dispense at least an amount of fuel equivalent to the fuel merchant credit amount. However, if all or a portion of the fuel merchant credit amount is used to purchase non-fuel goods or services from the fuel merchant, fuel station computing system 122 subtracts the cost of such non-fuel items from the fuel merchant credit amount, and uses any remaining fuel merchant credit to activate fuel dispensing mechanism 124. If the cost of any non-fuel goods or services plus the cost of dispensed fuel exceeds the fuel merchant credit amount, the remaining balance is paid using a credit card, check, cash, or another conventional payment method.

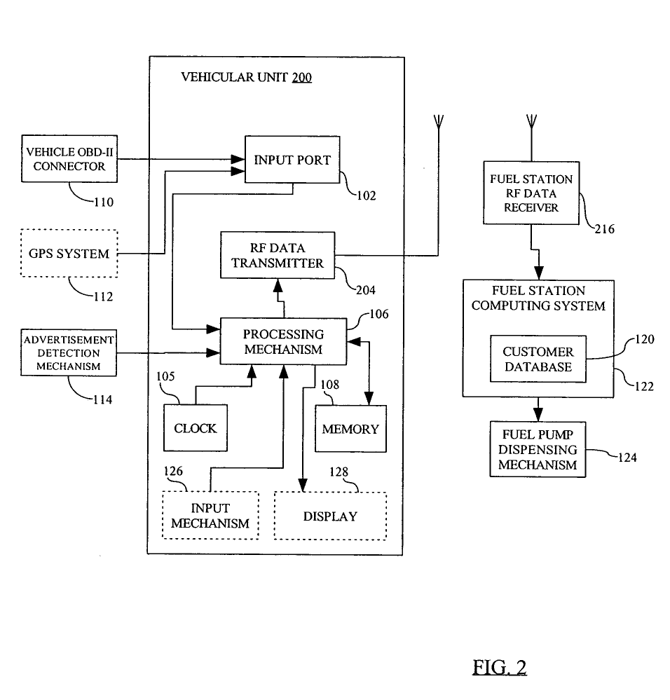

FIG. 2 is a hardware block diagram setting forth a system for administering electronic advertising contracts according to a second preferred embodiment of the invention. Like reference numerals in FIGS. 1 and 2 are used to refer to substantially identical hardware elements. However, the configuration of FIG. 2 employs a radio frequency (RF) data transmitter 204 in lieu of, or in addition to, output port 104 which was employed in the configuration of FIG. 1. Returning now to FIG. 2, RF data transmitter 204 is equipped for communicating with a fuel station RF data receiver 216 associated with a fuel merchant. In response to at least one of user input and proximity to fuel station RF data receiver 216, processing mechanism 106 is programmed to activate RF data transmitter 204 to electronically transmit a fuel merchant credit amount to fuel station RF data receiver 216. Optionally, at least one of RF data transmitter 204 and RF data receiver 216 are implemented using a data transceiver.

As before, the fuel merchant credit amount is determined by processing mechanism 106 retrieving one or more entries from the electronic advertisement display log in memory 108 and calculating at least one of distance driven while display of the advertisement was detected, time driven while display of the advertisement was detected, and total time elapsed while display of the advertisement was detected. Based upon any of the foregoing calculations, processing mechanism 106 determines a fuel merchant credit amount that specifies how much fuel credit is available for refueling the vehicle. Optionally, processing mechanism 106 determines the fuel merchant credit amount by using the foregoing calculations in conjunction with a predetermined vehicle value. The predetermined vehicle value is calculated as a function of one or more of: a) available window display area on the vehicle, b) vehicle make, model, and year, and c) intended vehicle use. Information relating to window display area, vehicle make, model and year, as well as intended vehicle use, may be entered into optional input mechanism 126 and stored in memory 108.

Optionally, all or a portion of the fuel merchant credit amount may be used to purchase non-fuel goods or services from a fuel merchant, such as soda, magazines, antifreeze, lottery tickets, or oil changes. Fuel station RF data receiver 216 electronically receives the fuel merchant credit amount from RF data transmitter 204 and sends the fuel merchant credit amount to a fuel station computing system 122 which activates a fuel pump dispensing mechanism 124 to dispense at least an amount of fuel equivalent to the fuel merchant credit amount. However, if all or a portion of the fuel merchant credit amount is used to purchase non-fuel goods or services from the fuel merchant, fuel station computing system 122 subtracts the cost of such non-fuel items from the fuel merchant credit amount, and uses any remaining fuel merchant credit to activate fuel dispensing mechanism 124. If the cost of any non-fuel goods or services plus the cost of dispensed fuel exceeds the fuel merchant credit amount, the remaining balance is paid using a credit card, check, cash, or another conventional payment method.

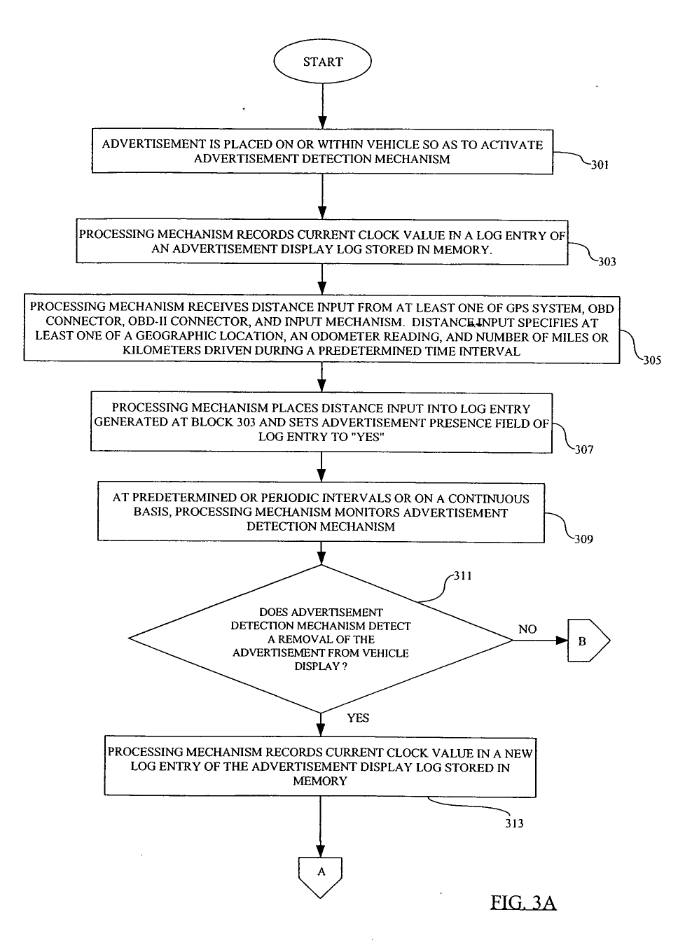

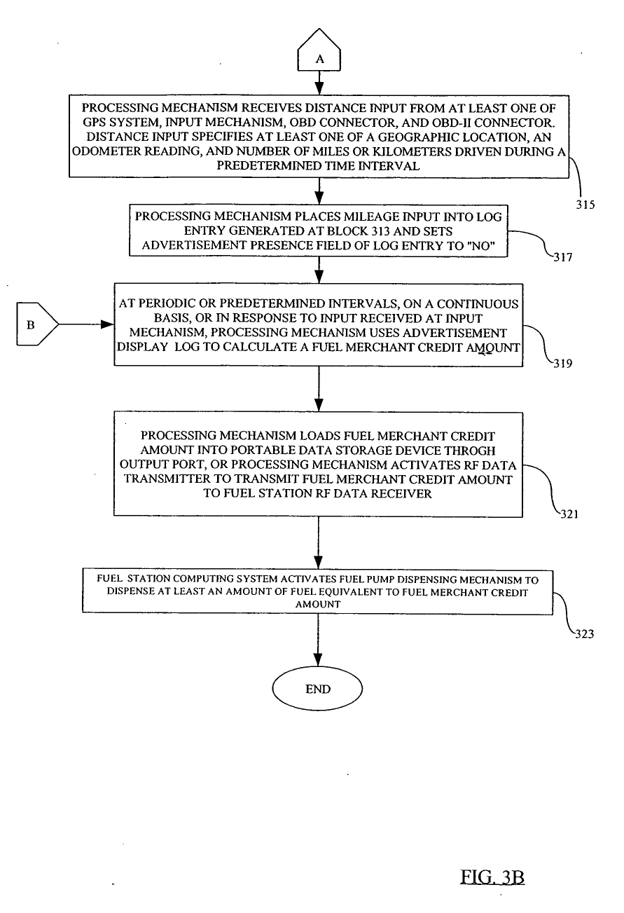

FIGS. 3A and 3B together comprise a flowchart setting forth an operational sequence performed by any of the systems of FIGS. 1 and 2. The operational sequence commences at block 301 where an advertisement is placed on or within a vehicle so as to activate advertisement detection mechanism 114 (FIGS. 1 and 2). Next, at block 303 (FIG. 3A), processing mechanism 116 (FIGS. 1 and 2) records the current value of clock 105 in a log entry of an advertisement display log stored in memory 108. At block 305 (FIG. 3A), the processing mechanism receives a distance (mileage) input from at least one of optional GPS system 112 (FIGS. 1 and 2), an OBD connector, OBD-II connector 110, and optional input mechanism 126. This distance input specifies at least one of a geographic location, an odometer reading, and number of miles or kilometers driven during a predetermined time interval.

At block 307 (FIG. 3A), the processing mechanism places the distance input of block 305 into the log entry generated at block 303. The processing mechanism sets an advertisement presence field in the log entry to “yes”. At predetermined or periodic intervals or on a continuous basis, the processing mechanism monitors the advertisement detection mechanism (block 309). At block 311, the processing mechanism performs a test to determine whether or not the advertisement detection mechanism detects a removal of the advertisement from vehicle display. If not, the program progresses to block 319 (FIG. 3B). The affirmative branch from block 311 leads to block 313 (FIG. 3A) where the processing mechanism records the current value of the clock in a new log entry of the advertisement display log stored in memory.

At block 315 (FIG. 3B), the processing mechanism receives a distance input from at least one of the GPS system, the input mechanism, the OBD connector, and the OBD-II connector. The distance input specifies at least one of a geographic location, an odometer reading, and the number of miles or kilometers driven during a predetermined time interval. Next, at block 317, the processing mechanism places the distance input of block 315 into the log entry generated at block 313, and sets the advertisement presence field of the log entry to “no”. At periodic or predetermined intervals, on a continuous basis, or in response to input received at the input mechanism, the processing mechanism uses the advertisement display log to calculate a fuel merchant credit amount (block 319). The fuel merchant credit amount is determined by calculating at least one of distance driven while display of the advertisement was detected, time driven while display of the advertisement was detected, and total time elapsed while display of the advertisement was detected. Based upon any of the foregoing calculations, the processing mechanism determines a fuel merchant credit amount that specifies how much fuel credit is available for refueling the vehicle. The processing mechanism electronically loads the fuel merchant credit amount into the portable data storage device through the output port, or the processing mechanism activates the RF data transmitter to electronically transmit the fuel merchant credit amount to the fuel station RF data receiver (block 321). The fuel station computing system activates the fuel pump dispensing mechanism to dispense at least an amount of fuel equivalent to the fuel merchant credit amount (block 323), and the program terminates. However, if all or a portion of the fuel merchant credit amount is used to purchase non-fuel goods or services from the fuel merchant, fuel station computing system 122 (FIG. 1) subtracts the cost of such non-fuel items from the fuel merchant credit amount, and uses any remaining fuel merchant credit to activate fuel dispensing mechanism 124 (FIG. 1). If the cost of any non-fuel goods or services plus the cost of dispensed fuel exceeds the fuel credit amount, the remaining balance is paid using a credit card, check, cash, or another conventional payment method.

Although the operational sequence of FIGS. 3A and 3B shows generation of log entries subsequent to removal or insertion of an advertisement into or from a display position on the vehicle, the invention also encompasses other log entry generation techniques which may be utilized in addition to, or in lieu of, the procedure of FIGS. 3A and 3B. For example, the processing mechanism may be programmed to initiate a new log entry at each of a plurality of periodic or predetermined distance or time intervals such that the advertisement detection mechanism is triggered to detect whether or not an advertisement is present in the display position at each of these intervals, and to record an appropriate parameter (yes=advertisement is present, no=advertisement has been removed) for each of these intervals. Illustratively, a new log entry could be created at ten-minute intervals, such that a record of whether or not an advertisement is being displayed is generated every ten minutes. Similarly, a new log entry could be generated at five-mile intervals, such that a record of whether or not an advertisement is being displayed is generated every five miles.

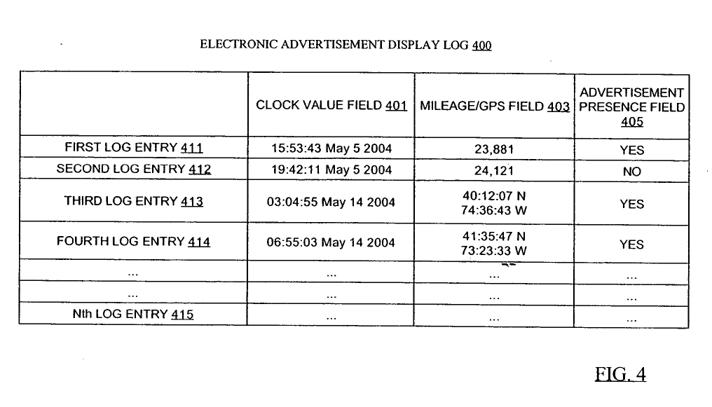

FIG. 4 is a data structure diagram showing an electronic advertisement display log 400 used to implement the operational sequence of FIGS. 3A and 3B. Electronic advertisement display log 400 is an electronic log that records each instance of an advertisement being inserted into a display position on the vehicle, and each instance of an advertisement being removed from a display position on the vehicle. Advertisement insertions and removals are tracked using distance, time, or both. Each of a plurality of log entries, such as first log entry 411, second log entry 412, third log entry 413, fourth log entry 414, and Nth log entry 415, associates a clock value field 401 with a mileage/GPS field 403 and an advertisement presence field 405. Clock value field 401 contains a value indicative of a date and a time. Alternatively, clock value field 401 may contain a value indicative of a number of elapsed seconds, minutes, and/or days subsequent to an arbitrarily-defined reference time. Mileage/GPS field 403 contains at least one of a mileage value, a kilometer value, and geographic coordinates in latitude and longitude. Advertisement presence field 405 contains a binary variable that specifies whether or not an advertisement is present in an advertisement display position on the vehicle.

Pursuant to an alternate embodiment of the invention, a vehicle is equipped with an advertisement presence detection mechanism for detecting continuous presence of an advertisement positioned for vehicle display throughout substantially all of a predetermined interval of time. The advertisement presence detection mechanism is coupled to a radio frequency identification (RFID) tag for transmitting information including a user identification and a variable indicative of whether or not continuous presence of the advertisement was detected throughout substantially all of the predetermined interval of time. Information transmitted by the RFID tag is received by a data receiver at a fuel merchant and, if continuous presence was detected, the received information is used to determine a fuel merchant credit amount.

The invention is not limited by the embodiments described above which are presented as examples only but can be modified in various ways within the scope of protection defined by the appended patent claims. Thus, while there have been described fundamental novel features of the invention as applied to various preferred embodiments thereof, it will be understood that various omissions and substitutions and changes in the form and details of the devices illustrated, and in their operation, may be made by those skilled in the art without departing from the spirit and scope of the invention. For example, it is expressly intended that all combinations of those elements and/or steps which perform substantially the same function in substantially the same way to achieve the same results are within the scope of the invention. Moreover, it should be recognized that structures and/or elements and/or steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An electronic advertising contract for granting fuel merchant credits in exchange for placement of advertising on private and/or commercial vehicles, wherein the contract is implemented using:
(a) a vehicle equipped with an advertisement detection mechanism for detecting at least one of presence of an advertisement positioned for vehicle display and absence of an advertisement positioned for vehicle display;
(b) a clocking mechanism;
(c) a memory;
(d) a processing mechanism, coupled to the advertisement detection mechanism, the clocking mechanism, and the memory; wherein the processing mechanism is programmed to generate an electronic advertisement display log in memory setting forth at least one of a time interval for which a display of the advertisement is detected, a time interval for which a display of the advertisement is not detected, a distance interval for which a display of the advertisement is detected, and a distance interval for which a display of the advertisement is not detected.

2. The electronic advertising contract of claim 1 wherein the advertisement display log is updated periodically or at predetermined intervals.

3. The electronic advertising contract of claim 1 wherein the advertisement display log is updated in response to at least one of detection of the presence of an advertisement and detection of the absence of an advertisement.

4. The electronic advertising contract of claim 1 wherein the processing mechanism is equipped with an input port for accepting data from at least one of a GPS system, an input mechanism, an OBD connector, and an OBD-II connector.

5. The electronic advertising contract of claim 4 wherein the electronic advertisement display log is updated by the processing mechanism receiving data from at least one of the clocking mechanism, the input mechanism, the GPS system, the OBD connector, and the OBD-II connector specifying at least one of a time and a mileage figure.

6. The electronic advertising contract of claim 5 wherein the processing mechanism is equipped with an output port for outputting data to a portable data storage device.

7. The electronic advertising contract of claim 6 wherein the portable data storage device includes at least one of a magnetic strip card, a smart card, an electronic key fob, a floppy disk, a memory stick, a compact flash card, a portable wireless transceiver, a wireless transmitter, and a portable radio frequency identification (RFID) tag.

8. The electronic advertising contract of claim 7 wherein the processing mechanism is programmed to load the portable data storage device with an electronic fuel credit amount determined by retrieving one or more entries from the electronic advertisement display log.

9. The electronic advertising contract of claim 8 wherein:
the processing mechanism uses the retrieved entries to calculate at least one of: (i) mileage driven while display of the advertisement was detected, (ii) time driven while display of the advertisement was detected, (iii) total time elapsed while display of the advertisement was detected, and (iv) a predetermined vehicle value determined as a function of one or more of: a) available window display area on the vehicle, b) vehicle make, model, and year, and c) intended vehicle use; and
based upon any of (i), (ii), (iii), and (iv), the processing mechanism determines an electronic fuel credit amount that specifies how much fuel credit is available for refueling the vehicle.

10. The electronic advertising contract of claim 9 wherein the fuel credit amount is based upon at least one of the amount of time that the advertisement was displayed with the vehicle, the number of miles that the vehicle was driven while displaying the advertisement, and the amount of time that the vehicle was driven while displaying the advertisement.

11. The electronic advertising contract of claim 10 wherein a fuel merchant is equipped with a merchant portable data storage device reader for reading the electronic fuel credit amount from the portable data storage device and accepting the electronic fuel credit in at least partial exchange for dispensing fuel into the vehicle.

12. The electronic advertising contract of claim 11 wherein the merchant portable data storage device reader receives the electronic fuel credit amount from the portable data storage device and sends the electronic fuel credit amount to a gas station computing system which activates a gas pump dispensing mechanism to dispense at least an amount of fuel equivalent to the electronic fuel credit amount.

13. The electronic advertising contract of claim 5 wherein the processing mechanism is equipped with a first RF data transceiver for communicating with a second RF data transceiver associated with a fuel merchant.

14. The electronic advertising contract of claim 13 wherein, in response to at least one of user input and proximity to the second RF data transceiver, the processing mechanism is programmed to activate the first RF data transceiver to transmit an electronic fuel credit amount to the second RF data transceiver.

15. The electronic advertising contract of claim 14 wherein the electronic fuel credit amount is determined by retrieving one or more entries from the electronic advertisement display log and calculating at least one of: (i) mileage driven while display of the advertisement was detected, (ii) time driven while display of the advertisement was detected, and (iii) total time elapsed while display of the advertisement was detected; and
based upon any of (i), (ii), and (iii), the processing mechanism determines an electronic fuel credit amount that specifies how much fuel credit is available for refueling the vehicle.

16. The electronic advertising contract of claim 14 wherein the second RF data transceiver receives the electronic fuel credit amount from the first RF data transceiver and sends the electronic fuel credit amount to a gas station computing system which activates a gas pump dispensing mechanism to dispense at least an amount of fuel equivalent to the electronic fuel credit amount.

17. An electronic advertising contract for granting fuel credits in exchange for placement of advertising on private and/or commercial vehicles, wherein the contract is implemented using:
(a) an advertisement presence detection mechanism for use on or within a vehicle to detect continuous presence of an advertisement positioned for vehicle display throughout substantially all of a predetermined interval of time; and
(b) a radio frequency identification (RFID) tag, coupled to the advertisement presence detection mechanism, for transmitting information including a user identification and a variable indicative of whether or not continuous presence of the advertisement was detected throughout substantially all of the predetermined interval of time.

18. The electronic advertising contract of claim 17 wherein information transmitted by the RFID tag is received by a data receiver at a fuel merchant and, if continuous presence was detected, the received information is used to determine a fuel merchant credit amount.
